(19) United States
(12) Patent Application Publication
(10) Pub. No.: US 2010/0288386 A1
(43) Pub. Date: Nov. 18, 2010

(54) Shower interval switch and alternating shower provided ...

(76) Inventor: Bernt Westarp, Ratingen (DE)

Correspondence Address: KF ROSS PC, 5683 RIVERDALE AVENUE, SUITE 203 BOX 900, BRONX, NY, 10471-0900, US

(21) Appl. No.: 11/660,844

(22) PCT Filed: Aug. 23, 2005
(86) PCT No.: PCT/DE05/01488

§ 371 Date: Oct. 2, 2007

(30) Foreign Application Priority Data
Aug. 23, 2004 (DE) 20 2004 013 195.1

(51) Int. Cl. B01F 5/04

(52) U.S. Cl. 137/896

(57) ABSTRACT

An interval switch means for a shower and an alternating shower provided with such an interval switch means are described. An automatic interval operation of the shower with alternating warm water and cold water phases according to a first embodiment is obtained by controlling a hot water line of the shower leading to the mixer into an open and closed condition. According to a second embodiment simultaneously a blocking element arranged in the line leading from the mixer to the shower head and a second blocking element arranged in a bypass line bypassing the mixer are controlled such that alternately warm water is discharged through the mixer and cold water is discharged through the bypass line. In this manner a shower can be redesigned into an alternating shower with simple means.

The present invention is directed to interval switch means for a shower comprising a cold water supply line, a warm water supply line, a mixer into which both lines open, a shower head and a single line leading from the mixer to the shower head. Furthermore, the invention is directed to a shower provided with such interval switch means.

It is known that alternating bathes have a stimulating, inuring and/or curing effect on the human body. With such alternating bathes the human body is alternately contacted with warm water and cold water. Similar effects result if such an alternating contact with warm water and cold water is realized by means of showers. So, it is known to manually actuate or adjust the shower or the mixer thereof for attaining such effects that the shower alternately supplies warm water and cold water over certain time intervals. However, each time if it is to be switched from warm water to cold water or vice versa a manual adjusting process has to be carried out which is uncomfortable and troublesome. This is especially uncomfortable and partly cannot be carried out at all with very short time intervals of the sequence of warm water and cold water since, when switching to warm water, again and again a regulation has to be carried out in order to reach the desired warm water temperature which is pleasant for the body.

From DE 202 07 365 U1 a so-called hot-cold-shower is known which has a mixing unit from which a double shower hose leads to a shower head provided with two chambers. This shower system is designed relatively complicated since a special expensive mixing unit is used and a double shower hose with an especially designed shower head is necessary. In addition to the customary operation conditions “cold shower” and “hot shower” an operation condition “hot-cold-shower” can be adjusted with this shower according to which hot water flows from one of the two chambers of the double shower head while simultaneously cold water flows from the second chamber. Accordingly, this embodiment is directed to the simultaneous discharge of cold water and hot water from a single shower head. Furthermore, it is pointed out in this publication that the blocking devices of the valve system can be controlled electrically by means of a computer and an operation panel at which the desired operation condition of the shower can be selected and can be adjusted. Moreover, a defined time can be selected over which the desired operation condition remains activated or after which the operation condition can be changed automatically. However, a special hint that with this shower alternately hot and cold water is to be discharged from both chambers of the double shower head is not contained in this publication.

It is the object of the present invention to provide interval switch means for a shower with which the shower can be refunctioned in a simple and comfortable manner into an alternating shower, i.e. a shower alternately discharging warm water and cold water in intervals.

According to the invention this object is achieved by interval switch means comprising a blocking element arranged in the warm water line, a control unit controlling the blocking element in an interval-like manner to open and close the same, and an operation unit for manually switching on and switching off the interval switch means and for manually inputting and clearing the lengths of the open intervals and closed intervals of the blocking element.

The inventive interval switch means is designed simply and can be handled comfortably. It has only one single blocking element which is arranged in the warm water supply line of the shower. This blocking element is controlled by a control unit in intervals into an open and closed condition whereby the alternating cold water and warm water supply of the shower is obtained. With an operation unit the user of the shower can switch on and switch off the interval switch means and can input and clear the lengths of the open and closed intervals of the blocking element.

The inventive interval switch means can be subsequently arranged or incorporated with already installed showers. This can be realized in a simple manner since the interval switch means makes necessary only three main parts. Of course, it can be also installed together with a conventional shower (new installation).

If the inventive interval switch means has been installed it is used in the following manner: the user of the shower adjusts a desired warm water temperature by means of the customary mixer of the shower. Subsequently, he carries out a shower process with the warm water adjusted to the desired temperature. If the shower shall now be operated as alternating shower appropriate lengths of the open and closed intervals are adjusted by means of the operation unit. These intervals can be identical or different from one another, for instance a 30 sec warm water interval and a 1 sec cold water interval can be adjusted. Then the interval switch means is manually switched on. Since the shower is already within the warm water supply modus the blocking element is initially not operated until the 30 sec warm water interval is expired. Then the control unit controls the blocking element which immediately closes the warm water supply line. Accordingly, only cold water flows to the shower head so that the desired 1 sec cold water supply is carried out. After termination of the cold water interval the blocking element is controlled again into an open condition so that now warm water is discharged again. When warm water is discharged not only hot water but also cold water flow to the mixer and are mixed by the same in a suitable manner.

Accordingly, with the inventive interval switch means the cold water supply line is never blocked but only throttled by the mixer in the customary manner in order to obtain warm water for a shower. The interval switch means itself does not act on the cold water supply line at all but only blocks the warm water line if the cold water interval is desired in the alternating shower modus. This function is very simple. Double shower heads or double hoses are not required, and the inventive interval switch means can be installed with every conventional shower.

Preferably, the adjustment of the cold water and warm water intervals in the alternating shower modus is carried out by means of a clock which is operated through the operation unit. The clock forms part of the control unit which then controls the blocking element in defined predetermined time distances.

The inventive interval switch means can be installed not only on the surface but also below the surface. If an existing shower system is to be subsequently provided with the interval switch means only an access to the warm water line upstream of the mixer has to be provided. At this position the blocking element is installed in the warm water supply line and an appropriate control line is connected to the same. The control line is placed to the control unit which can be installed as independent unit or together with the operation unit in a housing. A corresponding current supply to the operation unit or control unit, for instance accumulator supply or low voltage, has to be provided for.

Any known member can be used as blocking element, for instance a valve, gate, rotary gate, a flap etc. Corresponding members are known to the expert in the art and have not to be described and discussed in detail here.

Preferably, the controlling of the blocking element is carried out electromagnetically so that as control line only an electrical signal line has to be placed. In this case the blocking element is designed as solenoid valve, solenoid gate, solenoid rotary gate, solenoid flap etc.

Necessarily, the operation unit has an on-off-switch as well as means for manually inputting and clearing the lengths of the open and closed intervals of the blocking element. This can be an appropriate keyboard which is preferably designed as touch screen. Furthermore, the operation unit can have display means for displaying the desired warm water and cold water intervals.

The control unit controls the blocking element into an open and closed condition in response to the input commands. Since with the inventive interval switch means no metering of the warm water has to be carried but (this metering is caused by the mixer provided anyhow with the shower) only a control of the warm water supply line to open and close the same is necessary so that the blocking element and the corresponding control unit can have a simple design. Preferably, the control unit is a corresponding electronical member which can be programmed in an appropriate manner in order to carry out the desired commands. The adjustment of the desired interval lengths can be realized by means of the already mentioned clock.

Of course, the control unit and operating unit can be also designed as one unit and can have a single housing. Furthermore, it is also possible to combine the control unit and operating unit with the mixer so that one unit results.

Of course, the present invention cannot only be used with firmly installed shower heads but also with manual showers.

As described above, the operation of the blocking element is preferably carried out electromagnetically by means of a solenoid valve having an appropriate operating magnet. However, this does not exclude that the blocking element can be also operated fluidically or even mechanically. In this case, for instance, a pilot valve is opened and closed in an electromagnetically controlled manner wherein the pilot valve is located in a fluid line, for instance, which acts upon the real blocking element and opens and closes the same in a controlled manner. The fluid can be a special fluid or the water used for the shower.

In connection with the inventive interval switch means any mixers (mixing batteries) can be used, for instance mixing batteries on the surface, mixing batteries below the surface, thermostat mixing batteries, so-called shower panels etc. As mentioned above, the control unit and the operating unit can be designed separate from the mixer or can be also integrated into the same.

If it is mentioned in connection with the invention that the operating unit serves for manually inputting and clearing the lengths of the open and closed intervals of the blocking element, this does also include that firmly adjusted programs can be selected with the operating unit by means of manual operation of a key etc. For instance, these programs can be alternating shower programs with cold and warm water phases with varying lengths. Furthermore, they can be alternating shower programs with varying total length. So, for instance, a plurality of such programs can be firmly installed which can be selected by the operation of a respective key. Of course, the invention also provides that the programs can be changed by the operating unit through manually inputting new parameters.

In the above-described specification it is emanated that the operating unit, as customary, is stationarily installed, for instance at the wall of a shower room, especially in the region of the mixer. According to another embodiment of the inventive interval switch means, which can be especially simply installed and can be especially comfortably handled, the operating unit has a remote control device which can be manually handled and includes a transmitting section for controlling a receiving section associated with the control unit.

Accordingly, with this solution the operating unit is not designed as stationary unit which has to be installed, for instance, on or in a wall of the shower room of the alternating shower. Thus, during the installation of the interval switch means the installation work for the operating unit is no more necessary so that only the blocking element in the warm water supply line and the corresponding control unit with receiving section have to be installed. This is especially of great importance in connection with the subsequent installation of the inventive interval switch means in already existing showers.

Another advantage of this solution consists of a more comfortable handling for the user of the shower. The user can change the cold/warm water phases of the alternating shower process even during the real shower process at once since he can comfortably hold the operating unit in his hand during the showering and has not to operate a stationarily installed unit so that an optimum adaption to the special desires of the individual user can be achieved. Accordingly, on the whole an especially comfortable handling for the user of the shower results.

Preferably, the transmitting section of the remote control device which can be manually handled controls the receiving section wirelessly. However, the invention does not exclude that a control can be also realized otherwisely, for instance by means of infrared radiation, as this is the case with the remote control of television receivers, for instance. However, in this case provisions have to be made that transmitting section and receiving section are not separated by light barriers. Such an isolation does not have any significant importance when the signals are transmitted per radio waves so that in the last place this embodiment is preferred since here the receiving section can be also located within a wall etc.

Preferably, the remote control device has a water-tight housing so that a handling during the showering process in a shower cabin etc. is possible.

Preferably, the blocking element is a solenoid valve which is provided with electrical pulses for the actuation of the solenoid of the blocking element by the control unit. The control unit includes a receiving section which receives the radio signals of the remote control device and converts the same into appropriate electrical signals which are used in the control unit for the actuation of the blocking element. Furthermore, the control unit includes preferably an appropriate electronical member which is programmed through suitable software so that upon receipt of an on-pulse by the receiving section of the control unit the blocking element is actuated according to the pre-programmed schedule (total length of the alternating shower sequence, length of the individual cold/warm phases etc.). Furthermore, a reprogramming can be carried out by a manual input with the remote control unit, for instance with regard to the total length of the alternating shower sequence, the lengths of cold/warm phases etc., so that a very fast and comfortable change of the circumstances can be carried out in this manner.

According to another preferred embodiment of the invention the remote control device includes an operating panel with which a manual setting of a plurality of different firm programs is possible. According to this embodiment the user can very quickly change from one alternating shower program to another program by only having to carry out an operation process. Of course, the remote control device can also include an operation panel which enables the setting of a plurality of different firm programs and the variation of the total time of the alternating shower sequence and/or the individual times of the cold/warm phases.

The remote control device can have conventional press buttons or even a touch-screen for its operation.

Of course, the present invention includes also an alternating shower provided with an interval switch means according to which the operating panel includes a remote control device which can be manually handled.

According to the above-described embodiments according to which a single blocking element is disposed in the hot water line in the alternating shower modus only a throttled cold water supply occurs in the blocked condition of the blocking element since the mixer remains in the warm water position which was once set. Accordingly, the cold water flow is lower than the warm water flow. However, this is no significant disadvantage for the user of the shower.

However, if in the alternating shower modus no cold water supply throttled by the mixer is desired the invention provides a special embodiment according to which the interval switch means includes a bypass line bypassing the mixer, branching off the cold water line and extending into the line leading from the mixer to the shower head. In this bypass line a second blocking element is arranged which can be controlled by the control unit in an interval-like manner. According to this embodiment the second blocking element is controlled parallel with respect to the first blocking element in a reversed sense as the first blocking element. In other words, if the first blocking element in the hot water line is controlled to be closed the second blocking element in the bypass line is opened. If the first blocking element is controlled to be opened the second blocking element in the bypass line is controlled to be closed. By this it is achieved that in the alternating shower modus with blocked hot water supply (first blocking element in the closed position) the cold water supply occurs through the bypass line, i.e. through the complete cross-section of the line, and no more has to be carried out in a throttled manner through the mixer.

Instead of a blocking element directly arranged in the bypass line the second blocking element can be also realized by a two-way valve arranged at the branching point of the bypass line from the cold water line wherein the two-way valve can be switched there and back in an interval-like manner. Accordingly, with an opening of the first blocking element the two-way valve is brought into a position in which the bypass line is closed, and with a closing of the first blocking element the two-way valve is brought into a position in which the bypass line is opened and the cold water line to the mixer is closed.

Both blocking elements are controlled by the control unit in the above-described manner. Preferably, the second blocking element can be also an electromagnetically actuated valve (solenoid valve with appropriate operating magnet). Moreover, of course all the above-described embodiments are also true for the embodiment with two blocking elements. Especially, the invention is also directed to an alternating shower having the above-described two blocking elements.

Another solution of the invention is directed to an interval switch means of the above-cited kind which is characterized in that it comprises a first blocking element in the line leading from the mixer to the shower head, a bypass line bypassing the mixer, branching off the cold water line and extending into the line leading from the mixer to the shower head downstream of the first blocking element, a second blocking element arranged in the bypass line and a control unit controlling both blocking elements in an interval-like manner as well as an operating unit for manually switching on and off the interval switch means and for manually inputting and clearing the lengths of the open and closed intervals of both blocking elements.

Accordingly, with this embodiment, with which the above-cited object is achieved either, no more a blocking element arranged in the hot water line is used but two blocking elements are present of which one is arranged in the line leading from the mixer to the shower head and the other is arranged in the above-cited cold water bypass line. Accordingly, the embodiment is designed a little bit more extensive than the above-described embodiment according to which only a single blocking element is arranged in the hot water line, however, this embodiment can be used in such cases in which no blocking element is to be arranged in the hot water line leading to the mixer.

With this embodiment the alternating shower modus is carried out such that the first blocking element is opened and the second blocking element arranged in the bypass line is closed in the warm water interval. Accordingly, cold water flows to the mixer and is mixed there with hot water to obtain warm water which is supplied to the shower head. In the cold water interval then the first blocking element is closed and the second blocking element is opened. Then only cold water can flow to the shower head through the bypass line and the opened second blocking element. Both blocking elements are controlled to be opened and closed by the control unit in an interval-like manner in the above-cited modus. The first blocking element is opened when the second blocking element is closed and vice versa.

The second blocking element can be a blocking valve arranged in the bypass line or a two-way valve arranged at the branching point of the bypass line from the cold water line. If the first blocking element is opened the two-way valve is brought into a position in which the bypass line is closed. If the first blocking element is closed the two-way valve is brought into a position in which the bypass line is opened and the cold water line leading to the mixer is closed.

According to the above-described embodiment both blocking elements can be closed or the first blocking element can be closed and the two-way valve can be switched into the position blocking the bypass line by the operating unit and the control unit either. In this manner the shower can be switched off very quickly and simply.

Of course, the above-described second embodiment of the inventive interval switch means can be further designed in such a manner as this was described in detail in connection with the first embodiment. Accordingly, these special embodiments are not discussed again here. Of course, the invention is also directed to an alternating shower which includes an interval switch means of the above-described kind (second embodiment of the invention).

In the following the invention is described by means of examples in connection with the drawing in detail. Of the drawing

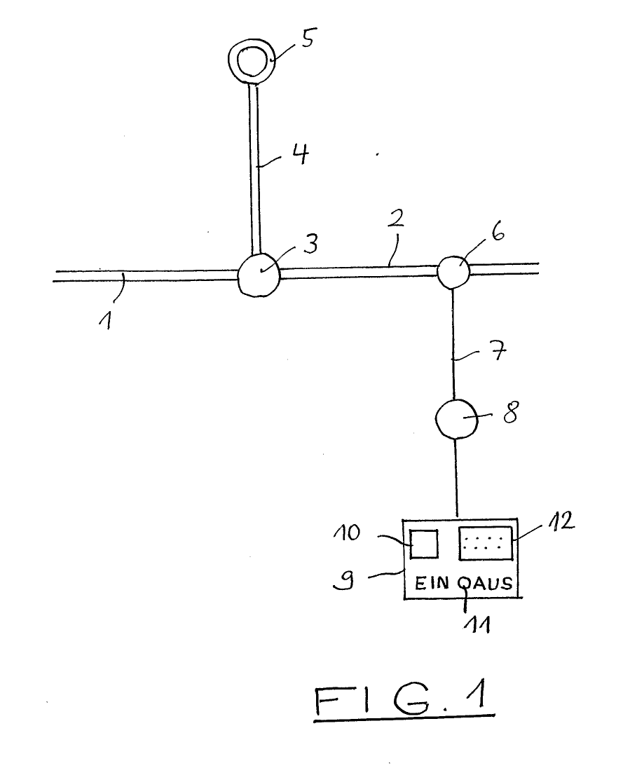

FIG. 1 shows a schematic representation of an alternating shower provided with an interval switch means;

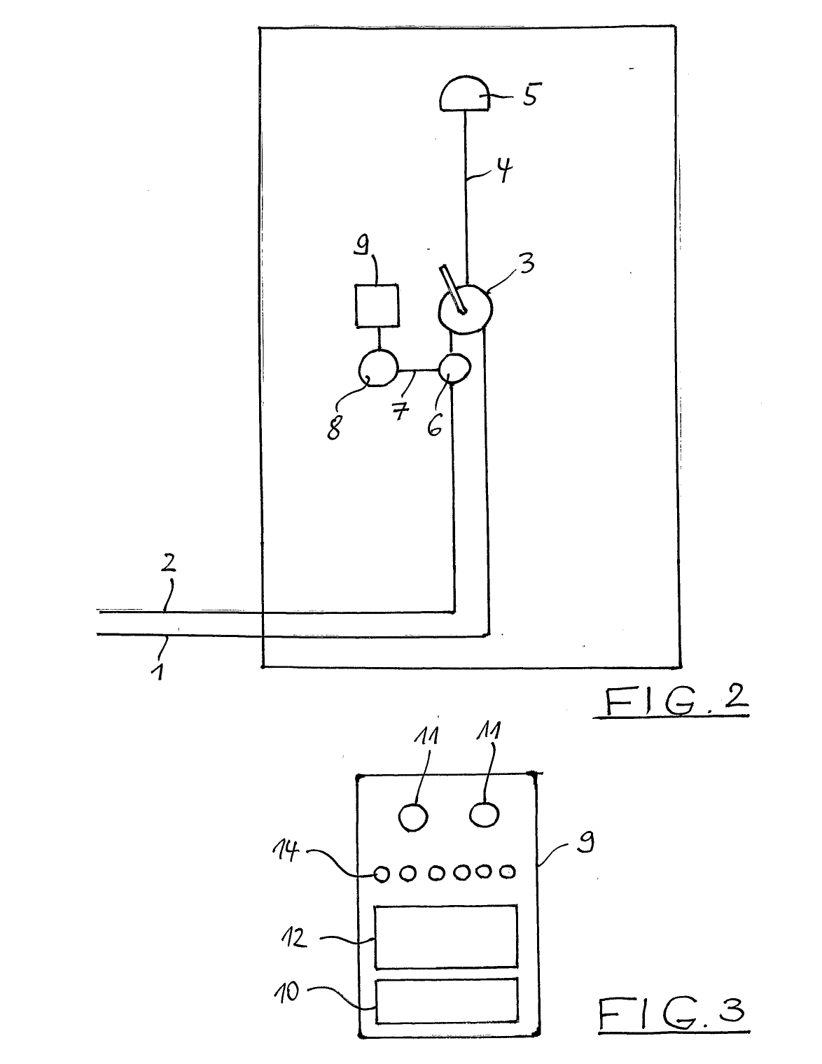

FIG. 2 shows a more detailed but still schematic representation of the alternating shower of FIG. 1;

FIG. 3 shows a schematic top view of the operating unit;

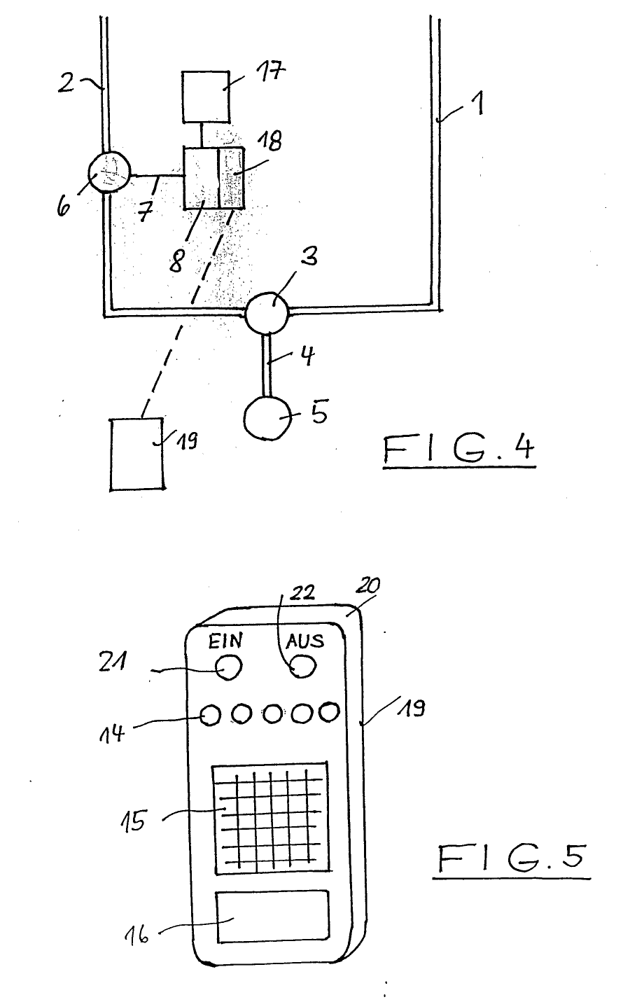

FIG. 4 shows a schematic representation of an alternating shower provided with an interval switch means of another embodiment of the invention;

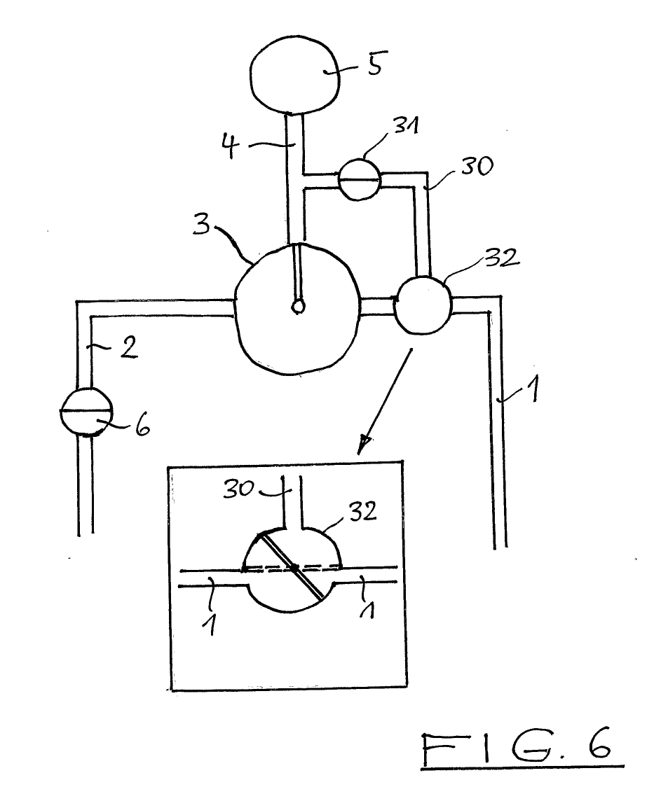

FIG. 5 shows a schematic spatial view of the operating unit of the embodiment of FIG. 4;

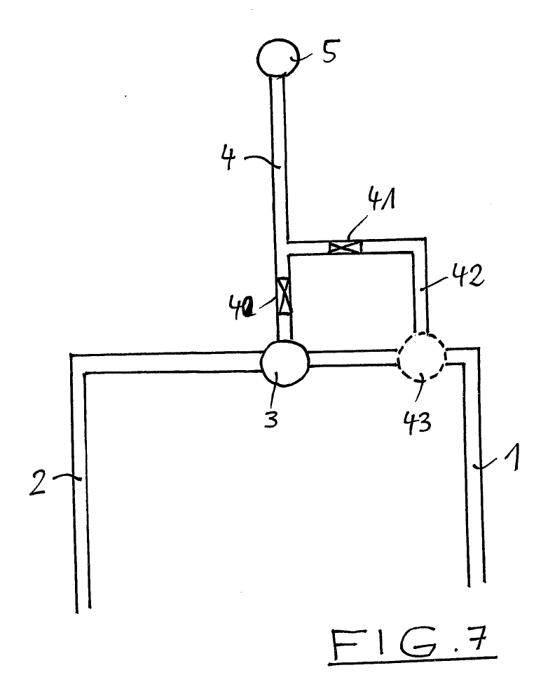

FIG. 6 shows a schematic representation of still another embodiment of an alternating shower provided with an interval switch means; and

FIG. 7 shows a schematic representation of another embodiment of an alternating shower provided with an interval switch means.

The shower schematically shown in FIG. 1 includes a cold water supply line 1 and a hot water supply line 2. Both lines extend into a mixer 3 of a known design which has means for switching on and switching off the shower as well as for mixing cold water and warm water. A single line 4 which is passed not only by cold water but also by hot water or warm water leads from the mixer 3 to a customary shower head 5. This corresponds to a shower of conventional design.

The real interval switch means is described in the following. This has an appropriate blocking element 6 which can be, for instance, an electromagnetically controlled blocking valve. The blocking element is incorporated into the warm water supply line 2 upstream of the mixer 3. By this, the warm water supply to the mixer can be blocked or can be opened. The actuation of the blocking element is done automatically through an appropriate control line 7 by means of which the electrical pulses for the actuation of the solenoid of the blocking element are supplied. The control line 7 emanates from a control unit 8 which can be an appropriate electronical member with programming. A possibility for manually inputting commands for the setting of the length of the on or off times of the blocking element 6 is realized by an operating panel 12 of an appropriate operating unit 9 which moreover includes an on and off switch 11 for the interval switch means and a display 10 for the set interval lengths. A corresponding current supply is not shown.

For simplification it is also possible to design the operating unit such that manually only one time period can be input which is valid not only for the open interval but also for the closed interval of the blocking element.

The above-used term “mixer” is to cover not only mixing armatures of known design but also individual valves for hot and cold with subsequently leading together both lines to the shower head.

With the interval switch means whatever periods for the open and closed intervals (warm/cold water) can be adjusted which preferably are in a range of seconds up to a range of minutes.

FIG. 2 shows a somewhat more detailed but still schematic representation of the shower of FIG. 1. One recognizes that the blocking element 6 arranged in the hot water line 2 is arranged adjacent to the mixer 3 and is electrically connected to the control unit 8 which is electrically connected to the operating unit 9. The blocking element 6, the control unit 8 and the operating unit 9 are only schematically shown. In reality preferably the control unit 8 and the operating unit 9 form a unit which is preferably arranged adjacent to the blocking element 6. The control unit 8 and the operating unit 9 can be also integrated into the mixer 3 so that together with the mixer a single unit results which is housed in a single housing.

FIG. 3 shows the operating unit 9 in a schematic enlarged representation. In contrast to the operating unit shown in FIG. 1 this unit is slightly modified since it includes various keys 14 for the manual input of corresponding parameters in addition to the display and the operating panel 12 wherein firmly installed alternating shower programs can be manually adjusted by these keys.

In FIG. 4 another embodiment of an interval switch means in connection with a partly represented shower is schematically shown. The schematically shown shower has a cold water supply line 1 and a hot water supply line 2. Both lines open into a mixer 3 of known design which includes means for switching on and switching off the shower as well as for mixing cold water and warm water. A single line 4 which is passed not only by cold water but also by hot water or warm water leads from the mixer 3 to a shower head 5. This corresponds to a shower of conventional design.

The real interval switch means is described in the following. This has an appropriate blocking element 6 which can be, for instance, an electromagnetically controlled blocking valve. The blocking element is incorporated into the warm water supply line 2 upstream of the mixer 3. By this, the warm water supply to the mixer can be blocked or opened (even only partly). The actuation of the blocking element 6 is automatically done by an appropriate control line 7 through which the electrical pulses for the actuation of the solenoid of the blocking element are supplied. The control line 7 emanates from a control unit 8 which can include an appropriate electronical member which can be programmed and/or which is firmly programmed. Furthermore, the control unit 8 comprises a receiving section 18 which is controlled by a later described operating unit designed as remote control device 19 by radio signals in order to cause a control of the blocking element 6 by the control unit 8. A corresponding current supply (accumulator, battery etc.) for the control unit 8 and the receiving section 18 is shown at 17.

The operating unit designed as remote control device 19 is shown in FIG. 5. The remote control device 19 includes a transmitting section (not shown) in order to send radio signals to the receiving section 18. The remote control device 19 has a water-tight housing 20, for instance made of an appropriate plastic material. A display 16 for displaying adjusted values, for instance the total length of the alternating shower sequence, the lengths of the individual cold/warm phases etc., is located on the front side of the housing 20. Furthermore, an ON-key 21 and an OFF-key 22 for switching the interval switch means on and off are shown. Various firmly adjusted programs for the alternating shower process can be adjusted by means of keys 14. Various parameters, for instance the total time for the alternating shower sequence, details for the cold/warm phases etc., can be input with the keyboard schematically shown at 15. The manual inputting possibilities can be realized through an appropriate keyboard, a touch-screen etc.

In use the user of the shower enters an appropriate shower room with the remote control device 19 in his hand. He switches on the shower customarily and adjusts a suitable water temperature (warm water) by actuation of the mixer 3. Now, if he wishes to actuate the alternating shower he presses the ON-key 21 on the remote control device 19. Now, a firmly installed alternating shower program with certain alternating warm phases and cold phases runs down. If the user wishes to select another program during the alternating shower process he presses a key of the keyboard 14. For instance, if he wishes to vary the warm/cold phases of this special program he inputs corresponding time values by means of the keyboard 15. The respective dates are displayed by means of the display 16. Upon termination of the alternating shower process the user presses the OFF-key 22.

Furthermore, the remote control device 19 has an appropriate current supply (not shown), for instance a battery, which is housed in the housing.

FIG. 6 shows a schematic representation of another embodiment of an interval switch means or a shower. As with the above-discussed embodiments also in this case a blocking element 6 is arranged in the hot water line 2 leading to the mixer 3. A corresponding cold water line 1 opens into the mixer either, and from the mixer a line 4 extends to the shower head 5. So far this embodiment is identical with the above-described embodiments.

Additionally, this embodiment has a bypass line 30 which bypasses the mixer 3 and branches off the cold water line 1 and opens into the line 4 leading to the shower head 5. A second blocking element 31 is located within the bypass line 30, or a two-way valve 32 is located at the branching point of the bypass line from the cold water line 1. The design of the two-way valve 32 is schematically shown in the enlarged section of FIG. 6.

Both blocking elements 6 and 31 or 32 are correspondingly controlled by the control unit 8 and the operating unit 9 (here hot shown) in order to enable an interval shower operation or alternating shower operation. The bypass line is closed by means of the second blocking element 31 or 32 if the first blocking element 6 is opened and vice versa. This means that with opened blocking element 6 and closed bypass line warm water and cold water flow to the mixer 3 and are mixed there so that warm water is supplied to the shower head through the line 4. This is realized by means of a warm water interval predetermined by the operating unit 9. Thereafter, it is switched to a cold water interval by closing the first blocking element 6 and opening the bypass line. Since the bypass line has the same flow section as the cold water line 1 now the shower head 5 is exclusively provided with cold water in a manner not throttled by means of the mixer. It is again switched to warm water etc. by another switching of the two blocking elements. As mentioned above, this embodiment has the advantage that no cold water discharge throttled by means of the mixer occurs within the cold water interval.

FIG. 7 shows schematically an embodiment of an interval switch means or of a shower according to which instead of the blocking element arranged in the hot water line 2 a first blocking element is arranged in the line 4 leading to the shower head and a second blocking element is arranged in a bypass line 42 bypassing the mixer 3. The bypass line 42 emanates from the cold water line 1 and opens into the line 4 leading to the shower head upstream of the first blocking element 40. This embodiment is provided for the case according to which no blocking element is to be arranged in the hot water line 2. However, herewith the same effect as with such an embodiment is obtained.

The second blocking element can be formed as blocking valve 41 which is located in the bypass line 42 or can be formed as two-way valve 43 shown with dotted lines and located at the branching point of the bypass line 42 from the cold water line 1. Both blocking elements are controlled by the control unit 8 and the operating unit 9 in such a manner that warm water and cold water are discharged alternately in intervals. Accordingly, the embodiment shown in FIG. 7 operates as the above-described embodiments.

In the warm water interval the first blocking element 40 is opened while the bypass line 42 is closed so that hot water and cold water can be customarily mixed in the mixer 3 and supplied to the shower head 5. In the cold water interval the first blocking element 40 is closed and the bypass line 42 is opened so that cold water flows to the shower head bypassing the mixer. If the bypass line 42 has the same flow cross section as the warm water line and cold water line the cold water flow rate corresponds to the warm water flow rate.

For instance, the two-way valve 43 can be a two-way valve that corresponds to the two-way valve shown in FIG. 6 and described in connection therewith. The second blocking element 41 can operate as the first blocking element 40.

Accordingly, the control unit 8 controls both blocking elements such that simultaneously the first blocking element is opened and the second blocking element is closed or is brought into a position closing the bypass line and that the first blocking element is closed and the second blocking element is opened or is brought into a position opening the bypass line. The corresponding opening and closing processes or position changing processes occur simultaneously.

1. An interval switch for a shower having a cold water supply line, a warm water supply line, a mixer into which both lines open, a shower head, and a single line leading from the mixer to the shower head, the switch comprising
a blocking element arranged in the warm water supply line,
a control unit controlling the blocking element in an interval-like manner to open and close the same, and
an operating unit for manually switching on and switching off the interval switch and for manually inputting and clearing the lengths of the open and closed intervals of the blocking element.

2. The interval switch according to claim 1, wherein the blocking element is a valve, a gate, a rotary gate or a flap.

3. The interval switch according to claim 1 wherein the blocking element is actuated electromagnetically.

4. The interval switch according to claim 1 wherein the operating unit has an adjustable clock.

5. The interval switch according to claim 1 wherein the operating unit includes a display for the input open and closed intervals of the blocking element.

6. The interval switch according to claim 1 wherein the interval switch is designed for the subsequent installation in existing showers.

7. An alternating shower comprising an interval switch according to claim 1.

8. The alternating shower according to claim 7 wherein the mixer is a mixing valve adapted to be manually actuated.

9. The alternating shower according to claim 8 wherein the mixer comprises a thermostat valve.

10. The interval switch according to claim 1 wherein the operating unit includes a remote control device adapted to be manually handled with a transmitting section for controlling a receiving section associated with the control unit.

11. The interval switch according to claim 10 wherein the transmitting section of the remote control device controls the receiving section per radio transmission.

12. The interval switch according to claim 10 wherein the remote control device includes an operating panel for the manual input of on/off commands, commands for adjusting the length of the open and closed periods of the blocking element and/or commands for adjusting the total length of an alternating shower sequence.

13. The interval switch according to claim 10 wherein the remote control device includes display means for displaying alternating shower parameters.

14. The interval switch according to claim 10 wherein the remote control device includes an operating panel for adjusting a plurality of various firm alternating shower programs.

15. The interval switch according to claim 10 wherein the remote control device includes a water-tight housing.

16. An alternating shower that includes an interval switch according to claim 10.

17. The interval switch according to claim 1 wherein the blocking element is adapted to be fluidically actuated.

18. The interval switch according to claim 1, further comprising
a pilot valve associated with the blocking element.

19. The interval switch according to claim 1 wherein the mixer, the control unit and the operating unit are formed as one unit.

20. The interval switch according to claim 1, further comprising
a bypass line bypassing the mixer, branching off the cold water line and opening into the line leading from the mixer to the shower head wherein a second blocking element is arranged in the bypass line which is adapted to be controlled in an interval-like manner by the control unit.

21. The interval switch according to claim 20 wherein the second blocking element is a two-way valve arranged at the branching point of the bypass line from the cold water line and controllable by the control unit to and fro in an interval-like manner.

22. An interval switch for a shower having a cold water supply line, a warm water supply line, a mixer into which both lines open, a shower head and a single line leading from the mixer to the shower head, the interval switch comprising:
a first blocking element in the line leading from the mixer to the shower head,
a bypass line bypassing the mixer, branching off the cold water line and opening into the line leading from the mixer to the shower head downstream of the first blocking element,
a second blocking element arranged in the bypass line, and a
control unit controlling both blocking elements in an interval-like manner as well as an operating unit for manually switching on and switching off the interval switch and for manually inputting and clearing the lengths of the open and closed intervals of both blocking elements.

23. The interval switch according to claim 22 wherein the second blocking element includes a blocking valve arranged in the bypass line or a two-way valve arranged at the branching point of the bypass line from the cold water line.

24. The interval switch according to claim 22 wherein both blocking elements are adapted to be switched into a closed condition or the first blocking element is adapted to be switched into a closed condition and the two-way valve is adapted to be switched into a position blocking the bypass line.

25. An alternating shower that comprises an interval switch according to claim 17.
